(19) United States
(12) Patent Application Publication
(10) Pub. No.: US 2015/0063496 A1
(43) Pub. Date: Mar. 5, 2015

(54) RECEIVER WITH NOISE COMPENSATION AND METHODS FOR USE THEREWITH

(71) Applicant: BROADCOM CORPORATION, Irvine, CA (US)

(72) Inventors: Nooshin Doctor Vakilian, Irvine, CA (US); Masoud Kahrizi, Irvine, CA (US); Alireza Tarighat Mehrabani, Irvine, CA (US)

(73) Assignee: BROADCOM CORPORATION, Irvine, CA (US)

(21) Appl. No.: 14/015,011

(22) Filed: Aug. 30, 2013

Related U.S. Application Data
(60) Provisional application No. 61/870,389, filed on Aug. 27, 2013.

(51) Int. Cl. H04L 27/26; H04L 25/03

(52) U.S. Cl. CPC H04L 27/2649; H04L 25/03159
USPC 375/340

(57) ABSTRACT

A receiver includes a radio frequency (RF) front end receives a received signal that is modulated via orthogonal frequency division multiplexing (OFDM) and generates a downconverted signal, based on the received signal. An OFDM demodulator generates subcarrier data based on the downconverted signal. The subcarrier data corresponds to a plurality of subcarriers. A subcarrier weighting module generates weighted subcarrier data by applying subcarrier weights to the subcarrier data corresponding to selected ones of the plurality of subcarriers. An OFDM decoder generates decoded OFDM data based on the weighted subcarrier data.

### CROSS REFERENCE TO RELATED PATENTS/PATENT APPLICATIONS

The present application claims priority based on 35 USC 119 to the provisionally filed application entitled, RECEIVER WITH NOISE COMPENSATION AND METHODS FOR USE THEREWITH, having Ser. No. 61/870,389, filed on Aug. 27, 2013, the contents of which are incorporated herein for any and all purposes, by reference thereto.

### BACKGROUND

1. Technical Field

The various embodiments generally relate to communication systems; and, more particularly, relate to OFDM receivers capable of noise compensation.

2. Description of Related Art

Depending on the type of wireless communication system, a wireless communication device, such as a cellular telephone, two-way radio, personal digital assistant (PDA), personal computer (PC), laptop computer, home entertainment equipment, etc., communicates directly or indirectly with other wireless communication devices. For direct communications (also known as point-to-point communications), the participating wireless communication devices tune their receivers and transmitters to the same channel or channels (e.g., one of the plurality of radio frequency (RF) carriers of the wireless communication system) and communicate over that channel or channels. For indirect wireless communications, each wireless communication device communicates directly with an associated base station (e.g., for cellular services) and/or an associated access point (e.g., for an in-home or in-building wireless network) via an assigned channel. To complete a communication connection between the wireless communication devices, the associated base stations and/or associated access points communicate with each other directly, via a system controller, via the public switch telephone network, via the Internet, and/or via some other wide area network.

1/f noise or pink noise refers to a phenomenon observed in many communication systems where noise power is distributed in inverse proportion to frequency. The reduction in the size of transistors used in RF receivers for higher speed and smaller area has an adverse effect on 1/f noise. The noise has the most impact on baseband signals at low frequencies.

### BRIEF DESCRIPTION OF THE SEVERAL VIEWS OF THE DRAWINGS

FIG. 1 is a diagram illustrating an embodiment of a wireless communication system.

FIG. 2 is a diagram illustrating an embodiment of orthogonal frequency division multiplexing.

FIG. 3 is a diagram illustrating an embodiment of components of a wireless receiver.

FIG. 4 is a diagram illustrating an embodiment of a subcarrier weighting module 312.

FIG. 5 is a diagram illustrating a plurality of subcarrier weights in accordance with an embodiment.

FIG. 6 is a diagram illustrating a plurality of subcarrier weights in accordance with a further embodiment.

FIG. 7 is a diagram illustrating another embodiment of a subcarrier weighting module 312′.

FIG. 8 is a flow diagram illustrating an embodiment of method.

FIG. 9 is a flow diagram illustrating an embodiment of method.

FIG. 10 is a flow diagram illustrating an embodiment of method.

FIG. 11 is a flow diagram illustrating an embodiment of method.

FIG. 12 is a diagram illustrating an embodiment of components of a wireless receiver.

### DETAILED DESCRIPTION

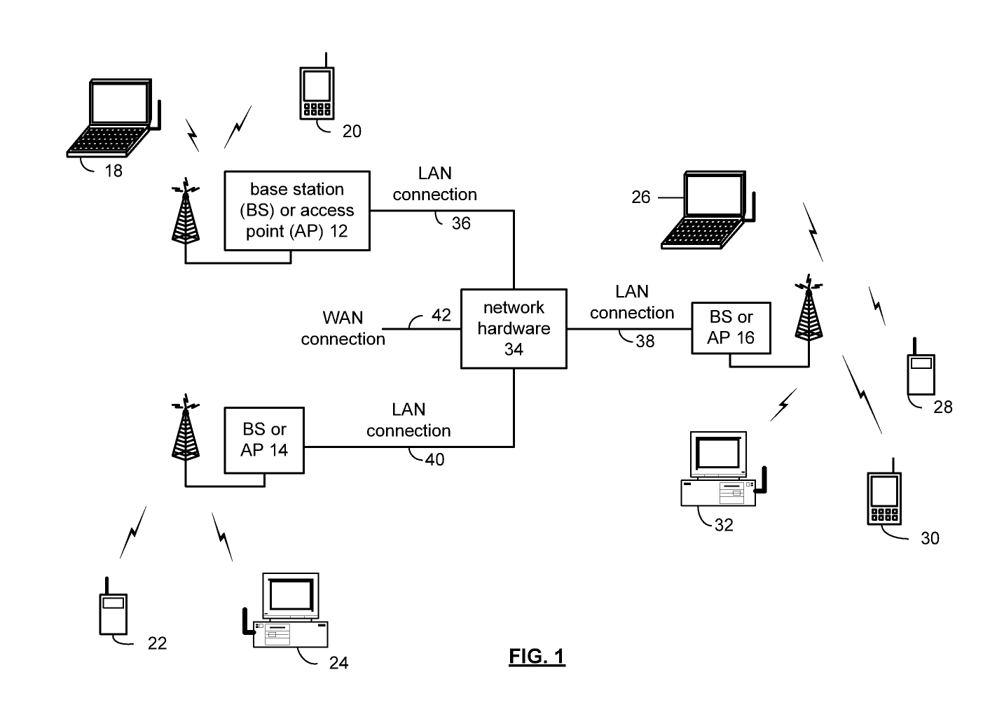

FIG. 1 is a diagram illustrating an embodiment of a wireless communication system. In particular, such a wireless communication system includes a plurality of base stations and/or access points 12-16, a plurality of wireless communication devices 18-32 and a network hardware component 34. The wireless communication devices 18-32 may be laptop host computers 18 and 26, personal digital assistant hosts 20 and 30, personal computer hosts 24 and 32 and/or cellular telephone hosts 22 and 28.

The base stations (BSs) or access points (APs) 12-16 are operably coupled to the network hardware 34 via local area network connections 36, 38 and 40. The network hardware 34, which may be a router, switch, bridge, modem, system controller, etc., provides a wide area network connection 42 for the communication system 10. Each of the base stations or access points 12-16 has an associated antenna or antenna array to communicate with the wireless communication devices in its area. Typically, the wireless communication devices register with a particular base station or access point 12-14 to receive services from the communication system 10. For direct connections (i.e., point-to-point communications), wireless communication devices communicate directly via an allocated channel.

Typically, base stations are used for cellular telephone systems (e.g., advanced mobile phone services (AMPS), digital AMPS, global system for mobile communications (GSM), code division multiple access (CDMA), local multi-point distribution systems (LMDS), multi-channel-multi-point distribution systems (MMDS), Enhanced Data rates for GSM Evolution (EDGE), General Packet Radio Service (GPRS), high-speed downlink packet access (HSDPA), high-speed uplink packet access (HSUPA and/or variations thereof) 3GPP (third generation partnership project), LTE (long term evolution), UMTS (Universal Mobile Telecommunications System) and like-type systems, while access points are used for in-home or in-building wireless networks (e.g., IEEE 802.11, Bluetooth, ZigBee, any other type of radio frequency based network protocol and/or variations thereof). Regardless of the particular type of communication system, each wireless communication device includes a built-in radio and/or is coupled to a radio. Such wireless communication devices may operate in accordance with the various embodiments as presented herein to enhance performance, reduce costs, reduce size, and/or enhance broadband applications.

In various embodiments, the wireless communication devices 18-32 include a wireless receiver having a subcarrier weighting module that is configurable to generate weighted subcarrier data by applying subcarrier weights to the subcarrier data corresponding to selected ones of a plurality of subcarriers.

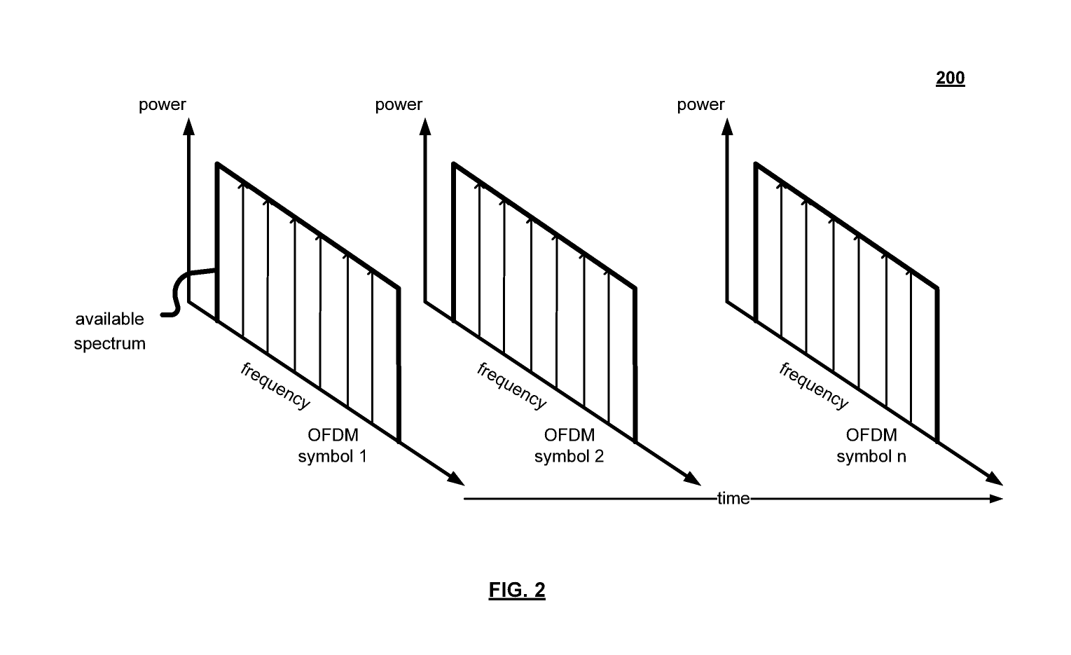

Further details including several optional functions and features spanning multiple embodiments are presented in conjunction with FIGS. 2-11 that follow.

FIG. 2 is a diagram illustrating an embodiment of orthogonal frequency division multiplexing. In particular, an OFDM modulation scheme is presented for use in conjunction with transmissions via the wireless communication devices 18-32. OFDM modulation may be viewed a dividing up an available spectrum into a plurality of narrowband sub-carriers (e.g., lower data rate carriers). Typically, the frequency responses of these sub-carriers are overlapping and orthogonal. Each sub-carrier may be modulated using any of a variety of modulation coding techniques.

OFDM modulation operates by performing simultaneous transmission of a larger number of narrowband carriers (or multi-tones). Oftentimes a guard interval (GI) or guard space is also employed between the various OFDM symbols to try to minimize the effects of ISI (Inter-Symbol Interference) that may be caused by the effects of multi-path within the communication system (which can be particularly of concern in wireless communication systems). In addition, a CP (Cyclic Prefix) may also be employed within the guard interval to allow switching time (when jumping to a new band) and to help maintain orthogonality of the OFDM symbols. Generally speaking, OFDM system design is based on the expected delay spread within the communication system (e.g., the expected delay spread of the communication channel).

FIG. 3 is a diagram illustrating an embodiment of components of a wireless receiver. The receiver 300 receives inbound received signal 320, such as an OFDM modulated RF signal that is received via an antenna, such as a single antenna or an antenna array that is not specifically shown. The RF front end 325 operates to process the received signal 320 into a downconverted signal, such as the digital downconverted signal 326. In operation, the low noise amplifier produces an amplified signal 322. Down conversion of the amplified signal 322 is performed via mixer 304 as well as filter 306 and an analog to digital conversion (ADC) module 308. The mixer 304 and filter 306 convert the amplified signal 322, based on a local oscillation 324, into an analog baseband or low IF signal. The ADC module 308 converts the analog baseband or low IF signal into the digital down converted signal 326 at baseband or low IF. While a particular configuration for RF front end is shown, other configurations are possible including configurations with other ordering of components, configurations with direct digital down conversion, etc.

The OFDM demodulation 310 and OFDM decoder 314 processes the baseband or low IF signal 156 in accordance with the particular OFDM modulation employed (e.g., IEEE 802.11, LTE, etc.) to produce decoded OFDM data 332. In particular, the OFDM demodulator 310 can implement a digital Fourier transform (DFT), such as a fast Fourier transform (FFT) or other time domain to frequency domain conversion to generate subcarrier data 328, based on the digital downconverted signal 326. The subcarrier data 328 corresponds to the OFDM subcarriers. This subcarrier data 328 can include, for example, the phase and amplitude (or real and imaginary components) corresponding to each of the OFDM subcarriers of the digital down converted signal 326.

In some receivers 300, the 1/f noise around DC may be significant. Consider a case where the receiver 300 is an LTE OFDM receiver. Each LTE Resource Block consists of 12 subcarriers. When a single RB (Resource Block) is allocated around DC, there could be significant degradation in sensitivity depending on 1/f noise profile. The subcarriers that are near DC can be significantly effected by 1/f noise. In LTE systems a small allocation of frequency band around DC can be assigned to any user at any time. 1/f noise can have a significant effect on throughput. Increasing transistor size will mitigate some of the degradation but at the cost of size and current consumption. Reduction in 1/f noise without increasing the transistor size can be an advantage.

The subcarrier weighting module 312 generates weighted subcarrier data 330 by applying subcarrier weights to the subcarrier data corresponding to selected ones of the plurality of subcarriers. In an embodiment, the selected ones of the plurality of subcarriers include one or more low frequency subcarriers and the subcarrier weights compensate for 1/f noise. The OFDM decoder 314 generates decoded OFDM data 332 based on the weighted subcarrier data. The processing performed by the OFDM decoder 314 can include, but is not limited to, demapping, depuncturing, decoding, and/or descrambling.

As shown, the receiver 300 further includes a temperature sensor 340 that is coupled to generate temperature data 342 that indicates a temperature associated with the RF front end 325, a chip associated with the receiver 300, a transceiver that includes receiver 300 or the communication device that includes such a receiver or transceiver. The temperature sensor 300 can include a thermocouple, thermistor or other temperature sensor 340. RF front end 325 generates a gain signal 352 that indicates an analog gain of low noise amplifier 300, an automatic gain control signal associated with low noise amplifier 300 or RF front end 325 or other receiver gain. Controller 350 responds to gain signal 352, the temperature signal 342 and generates control data 354 in response thereto that indicates the associated gain and temperature and optionally includes a trigger signal or other signal that indicates a changes in temperature or gain. In operation, the subcarrier weighting module 312 optionally generates subcarrier weighted data 330 based on the control data 354.

Note that the controller 350, OFDM demodulator 310, the subcarrier weighting module 312 and OFDM decoder 314 can be implemented using a shared processing device, individual processing devices, or a plurality of processing devices and may further include memory. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on operational instructions. The memory may be a single memory device or a plurality of memory devices. Such a memory device may be a read-only memory, random access memory, volatile memory, non-volatile memory, static memory, dynamic memory, flash memory, and/or any device that stores digital information. Note that when the controller 350, OFDM demodulator 310, the subcarrier weighting module 312 and/or OFDM decoder 314 implement one or more of their functions via a state machine, analog circuitry, digital circuitry, and/or logic circuitry, the memory storing the corresponding operational instructions is embedded with the circuitry comprising the state machine, analog circuitry, digital circuitry, and/or logic circuitry.

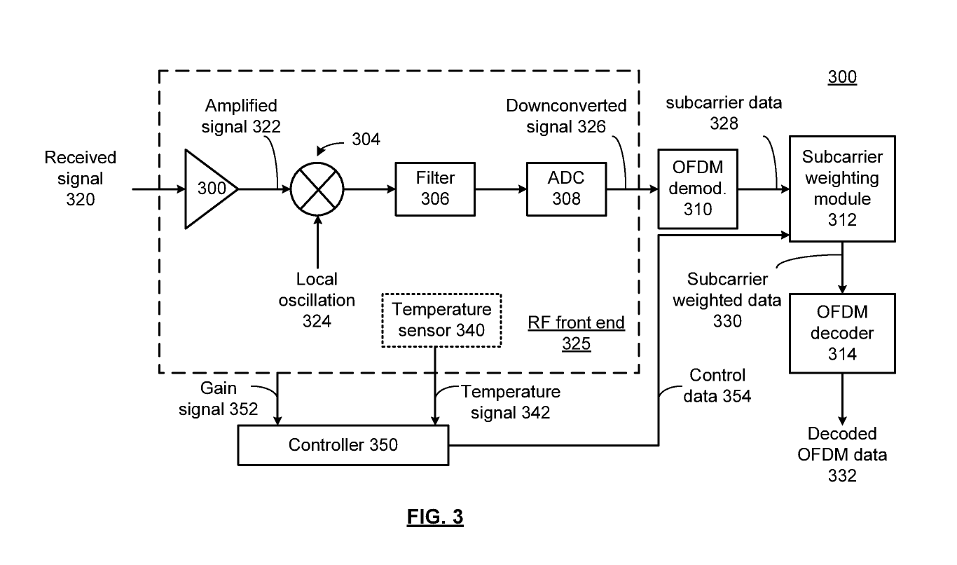

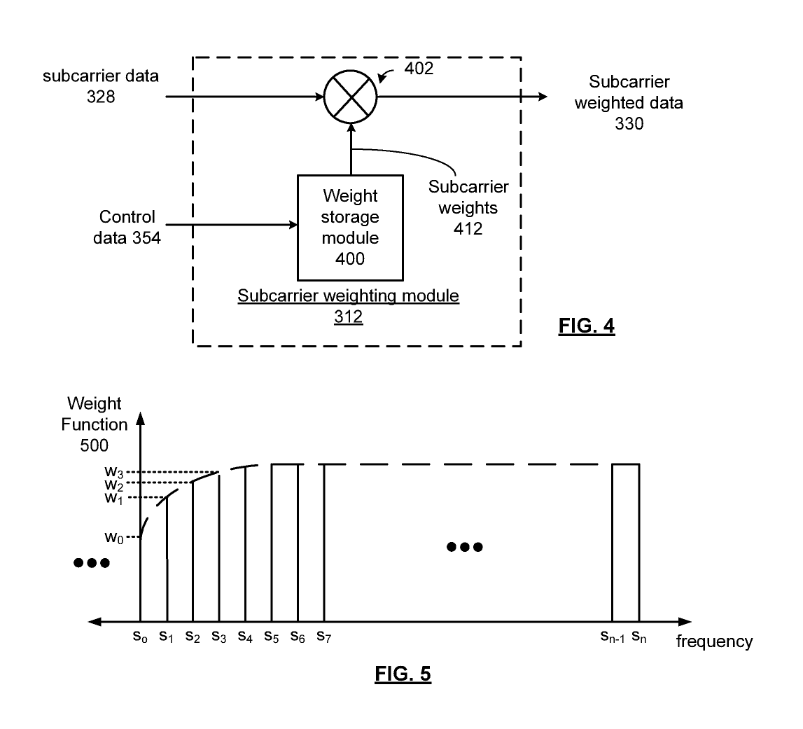

Further examples of operation of subcarrier weighting module 312, including several optional functions and features, are presented in conjunction with FIGS. 4-11 that follow.

FIG. 4 is a diagram illustrating an embodiment of a subcarrier weighting module 312. In particular, the subcarrier weighting module 312 includes a weight storage module 400, such as a memory that is configurable to store the subcarrier weights 412 corresponding to selected ones of the plurality of subcarriers. The multiplier 402 multiplies the subcarrier weights 412 by the subcarrier data 328 corresponding to the selected ones of the plurality of subcarriers. In this fashion, selected subcarriers can be weighted, for example, to compensate for noise, such as 1/f noise.

The operation of subcarrier weighting module 312 can be described in conjunction with the example that follows. The 1/f noise profile is inherent to the device and can be either measured or estimated. In particular, the 1/f noise, represented by the noise variance σₙ², can be represented as a function of frequency as:

1/f noise=σₙ²(f)

The weight storage module 400 can store subcarrier weights 412 in accordance with a a weight function (SNR) that reflects the inverse of 1/f noise profile.

SNR(f)=1/σₙ²(f)

Considering a particular weight, wᵢ, corresponding to a subcarrier having a frequency fᵢ, value of the weight can be represented as:

wᵢ=SNR(fᵢ)=1/σₙ²(fᵢ)

Consider the case where the function σₙ²(f) is normalized as follows:

the limit as fᵢ→∞,wᵢ=1

the limit as fᵢ→0,wᵢ=α

where α is a constant, such as zero or a nonzero constant.

In an embodiment, all subcarriers are weighted based on the formula for wᵢ above. In another embodiment, weights are applied to only selected ones of the subcarriers. In particular, at higher frequencies, where the 1/f noise is negligible, the value of the weighting function would be approximately 1. In an embodiment, the subcarrier weights are selected as only those subcarriers where:

(1−wᵢ)>β

where β represents a significance threshold. In this case, the power in the effected subcarriers will be reduced according to estimated noise impact on these subcarriers, as a function of their frequency. The other subcarriers, where the 1/f noise is negligible, are left unchanged. This has the same effect as assigning the values of the weights wᵢ as:

If(1−wᵢ)>β,

wᵢ=SNR(fᵢ)=1/σₙ²(fᵢ)

If(1−wᵢ)≦β,

wᵢ=1

In operation, the function SNR(f) can be determined for a particular class of receiver via device characterization over temperature, analog gain and/or other measurements for the particular wafer process that is employed. The subcarrier weighting module 312 can be configurable to adjust the subcarrier weights 412 to changing noise conditions. In particular, the weight storage module 400 can include a look-up table, state machine or other device that stores the subcarrier weights 412 to be used for various conditions including temperature and analog gain. The information will be saved once on the device and regularly accessed to decide on the subcarrier weights 412. Control data 354 that reflects the current operating conditions of the receiver can be used by weight storage module 400 to select the appropriate subcarrier weights 412 to reflect these operating conditions. In an embodiment, the weight storage module 400 operates based on control data 354 that indicates temperature and/or gain variations. Whenever the control data 354 indicates that the temperature, gain or a weighted combination thereof, changes by more than a threshold, the weight storage module 400 can be triggered to update the subcarrier weights 412.

While the embodiments above discuss weighting functions that are based on inverse noise variance scaling, other weighting functions can be used as well. For example effective SNR as a function of frequency (such as the ratio of signal variance to noise variance) may be used. For the edge of band frequency drops (due to analog filters), the SNR based scaling may provide a better weighting function. In some cases, if the filtering effect at the edge of the band scales both signals and noise power equally (under some conditions and implementations), then the SNR value would still be as good as other subcarriers. In this case, using an SNR weighting option does not penalize the edge of band subcarriers (since the SNR may be as good as others despite the filtering effects). Further, some implementations may dynamically select between different weighting functions based on current conditions and/or may programmably employ a selected one of a plurality of different noise profiles or weighting functions, etc.

FIG. 5 is a diagram illustrating a plurality of subcarrier weights in accordance with an embodiment. In particular, an example weight function 500 is presented as a function of frequency. A plurality subcarrier frequencies are presented (S₀, S₁, S₂, . . . Sₙ₋₁, Sₙ). In the example shown, the subcarrier weights (w₀, w₁, w₂, w₃) are generated based on the value of the weight function 500. No subcarrier weights are generated for higher frequencies where the effect of 1/f noise is negligible. In the alternative, the subcarrier weights corresponding to (S₄, . . . Sₙ₋₁, Sₙ) could be set to one.

While positive frequencies are presented, one skilled in the art will recognize that subcarrier data 328 could likewise include negative frequencies, and the weight function 500 could, for example, be mirrored about the origin. In this circumstance,

w−₁=w₁

w−₂=w₂

w−₃=w₃

and further, the subcarrier weights corresponding to (S−₄, . . . S−ₙ₊₁, S−ₙ) could be either set to equal one or not used.

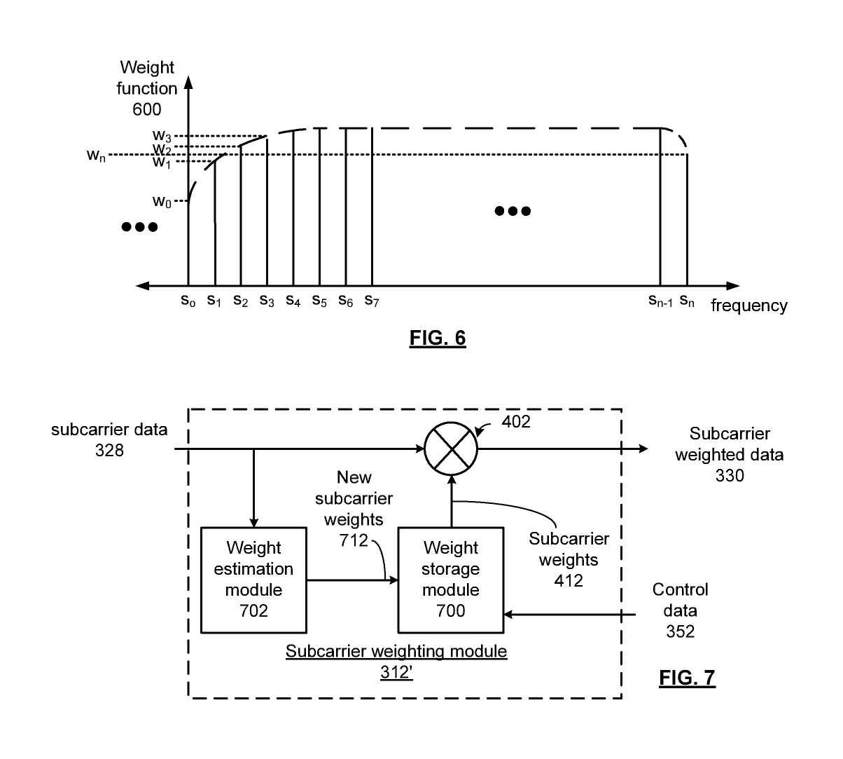

FIG. 6 is a diagram illustrating a plurality of subcarrier weights in accordance with a further embodiment. While the forgoing description has focused on compensating for the effects of 1/f noise, other noise that disproportionally affects the subcarrier data can likewise be compensated for by the application of subcarrier weights wᵢ.

For example, the techniques described in conjunction with FIGS. 1-5 can be applied further to enhance performance by mitigating analog filter roll-off on subcarriers near the edge of the an OFDM band. In particular, desired signal power roll-off due to imperfect analog filtration at the edge of the bandwidth will cause throughput degradation due to any added noise after the filtering (i.e. ADC noise). The performance degradation can be more pronounced if a single resource band is located at the edge of the signal bandwidth. As discussed in conjunction with compensation for 1/f noise, the power in subcarriers close to the edge of the band are reduced with a weight function proportional to the filter roll-off profile, in order to improve throughput.

In the example shown, an alternative weight function 600 is presented that takes into consideration not only 1/f noise, but noise in the subcarrier having a frequency Sₙ at the edge of the OFDM band. In this case, the weighting function 600 generates a subcarrier weight wₙ to compensate for this filter rolloff. While a rolloff is shown as being compensated for by a single a subcarrier at the edge of the OFDM band, two or more frequencies can be compensated for in a similar fashion. Further, while positive frequencies are presented, one skilled in the art will recognize that subcarrier data 328 could likewise include negative frequencies, and the weight function 600 could, for example be mirrored about the origin. In this circumstance,

w−ₙ=wₙ

FIG. 7 is a diagram illustrating another embodiment of a subcarrier weighting module 312′. In particular, subcarrier weighting module 312′ operates in a similar fashion to subcarrier weighting module 312, but instead of relying solely on the selection of stored values of the subcarrier weights, the weight estimation module 702 is configurable to generate and/or dynamically adjust new subcarrier weights 712 based on a noise estimation of current conditions. The new subcarrier weights 712 are stored in weight storage module 700 and used as updated subcarrier weights 412.

In an embodiment, initial subcarrier weights 412 are retrieved from a memory of weight storage module 700—either as the last set of subcarrier weights used or a default set of subcarrier weights that are based on control data 354. The weight estimation module 702 operates based on subcarrier data 328 to measure a noise profile during downtime of the receiver. The noise profile can include 1/f noise, band edge noise and other noise components. Once the estimated noise profile is calculated, a weight function can be calculated, such as via an inverse operation. The weight function can be used to generate new subcarrier weights 712 in a manner similar to the techniques described in conjunction with FIGS. 2-6 and can be applied to the subcarrier data 328 as the subcarrier weights 412 during normal RX operation.

In an embodiment, the weight estimation module 702 operates based on control data 354 that indicates temperature and/or gain variations. Whenever the control data 354 indicates that the temperature, gain or a weighted combination thereof, changes by more than a threshold, the noise measurement and weight estimation procedures can be triggered to generate new subcarrier weights 712.

In one mode of operation, the weight estimation module 702 detects a quiescent period of the receiver. This quiescent period can be detected by measurement, across all subcarriers, of a total received power or energy received over a period of time, and determination that such power or energy is below a threshold indicates the lack of a valid receive signal or other quiescent conditions. The noise estimation can be generated during this quiescent period on a subcarrier basis by averaging the subcarrier strength over time via a time windowing approach, an exponentially weighted moving average or other filtration. The subcarrier weights can be generated based on the noise estimation by calculating an inverse, and by selecting subcarrier weights based on the significance of the measured noise, as previously described. The calculation can be performed and re-performed at different times when quiescent periods are detected in order to adjust the subcarrier weights to changing noise conditions.

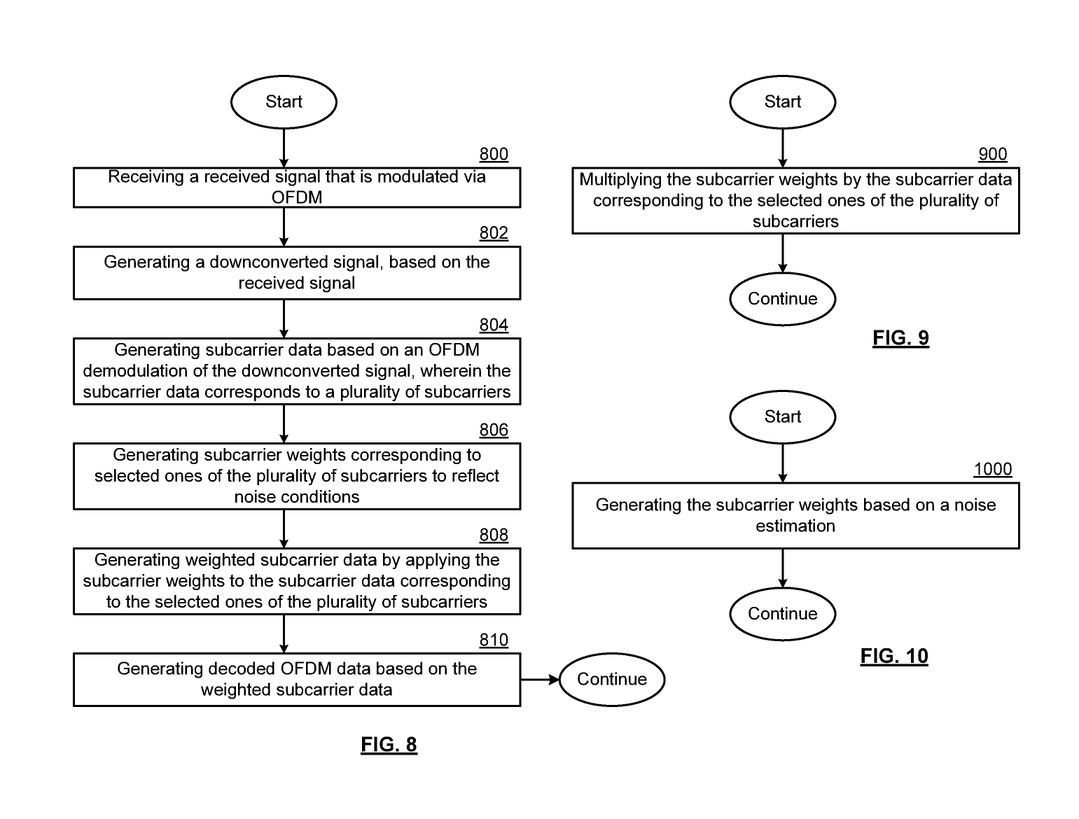

FIG. 8 is a flow diagram illustrating an embodiment of method. In particular, a method is presented for use in conjunction with one or more functions and features presented in conjunction with FIGS. 1-7. Step 800 includes receiving a received signal that is modulated via orthogonal frequency division multiplexing (OFDM). Step 802 includes generating a downconverted signal, based on the received signal. Step 804 includes generating subcarrier data based on an OFDM demodulation of the downconverted signal, wherein the subcarrier data corresponds to a plurality of subcarriers. Step 806 includes generating subcarrier weights corresponding to selected ones of the plurality of subcarriers to reflect noise conditions. Step 808 includes generating weighted subcarrier data by applying the subcarrier weights to the subcarrier data corresponding to the selected ones of the plurality of subcarriers. Step 810 includes generating decoded OFDM data based on the weighted subcarrier data.

In an embodiment, the selected ones of the plurality of subcarriers include at least one low frequency subcarrier and the subcarrier weights compensate for 1/f noise. The received signal can be modulated within an OFDM band, the selected ones of the plurality of subcarriers include at least one subcarrier at an edge of the OFDM band and the subcarrier weights can compensate for filter rolloff at the edge of the OFDM band.

Step 806 can include detecting a quiescent period and generating the noise estimation during the quiescent period. Step 806 can further include adjusting the subcarrier weights to changing noise conditions.

FIG. 9 is a flow diagram illustrating an embodiment of method. In particular, a method is presented for use in conjunction with one or more functions and features presented in conjunction with FIGS. 1-8. Step 900 includes multiplying the subcarrier weights by the subcarrier data corresponding to the selected ones of the plurality of subcarriers.

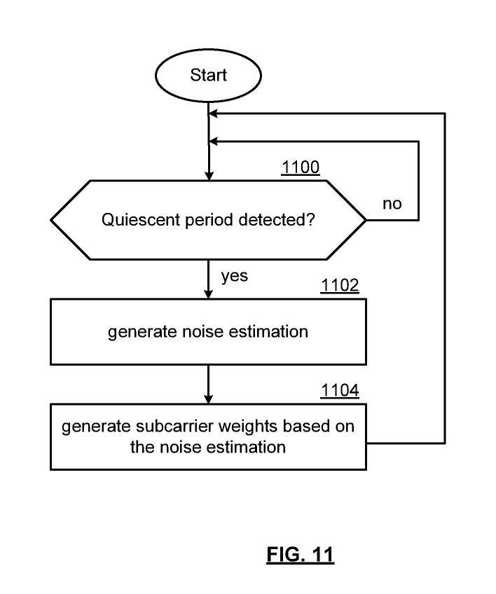

FIG. 10 is a flow diagram illustrating an embodiment of method. In particular, a method is presented for use in conjunction with one or more functions and features presented in conjunction with FIGS. 1-9. Step 1000 includes generating the subcarrier weights based on a noise estimation.

FIG. 11 is a flow diagram illustrating an embodiment of method. In particular, a method is presented for use in conjunction with one or more functions and features described in conjunction with FIGS. 1-10. In step 1100, determines if a quiescent period of the receiver is detected. This quiescent period can be detected by measurement, across all subcarriers, a total received power or energy received over a period of time, and determination that such power or energy is below a threshold indicates the lack of a valid receive signal or other quiescent conditions. If the quiescent period is not detected, the method loops back. If a quiescent period is detected, a noise estimation can be generated as shown in step 1102. As discussed, the noise can be estimated on a subcarrier basis by averaging the subcarrier strength over time via a time windowing approach, an exponentially weighted moving average or other filtration. The subcarrier weights are generated based on the noise estimation as shown in step 1104. In an embodiment, the subcarrier weights can be generated based on the noise estimation by calculating an inverse, and by selecting subcarrier weights based on the significance of the measured noise, as previously described. The calculation can be performed and re-performed at different times when quiescent periods are detected in order to adjust the subcarrier weights to changing noise conditions.

The noise estimation can include an estimation of 1/f noise. The received signal can be modulated within an OFDM band and the noise estimation can include an estimation of noise at the edge of the OFDM band.

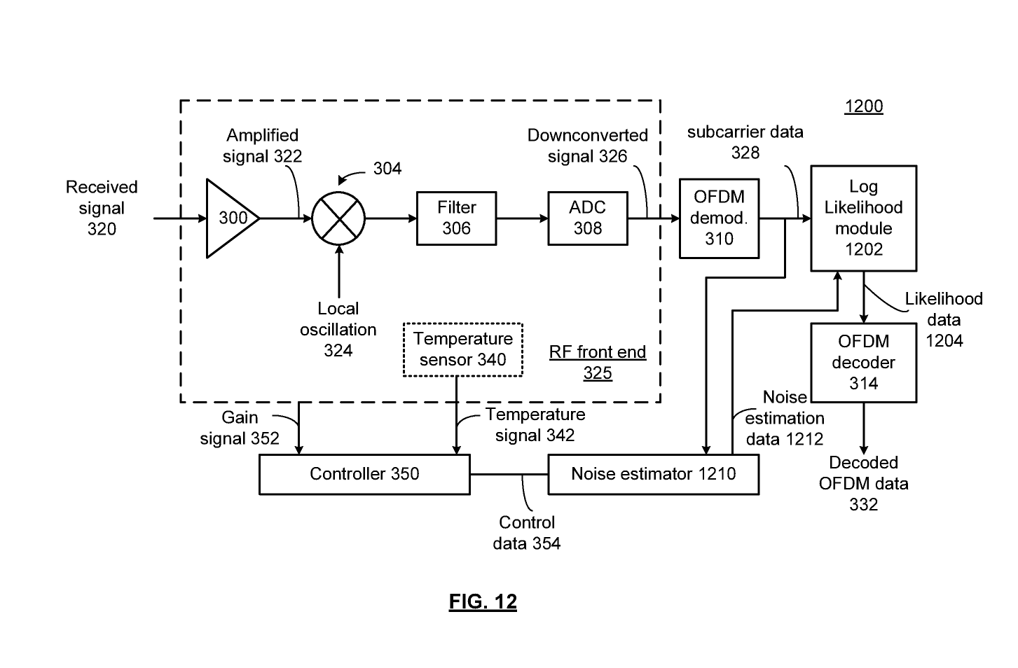

FIG. 12 is a diagram illustrating an embodiment of components of a wireless receiver. In particular, receiver 1200 includes many common elements to receiver 300 that are referred to by common reference numerals. In this embodiment, noise estimator 1210 generates noise estimation data 1212 based on subcarrier data 328 and control data 354. In operation, the noise estimation module 1210 processes subcarrier data 328 to measure a noise profile during downtime of the receiver 1200. The noise profile can include 1/f noise, band edge noise, noise variance and other noise components and or other noise estimation data 1212. In an embodiment, the noise estimation module 1210 operates based on control data 354 that indicates temperature and/or gain variations. Whenever the control data 354 indicates that the temperature, gain or a weighted combination thereof, changes by more than a threshold, the noise measurement and weight estimation procedures can be triggered to generate new noise estimation data 1212.

In an alternative embodiment, the noise estimator 1210 can utilize a noise function that is determined for a particular class of receiver via device characterization over temperature, analog gain and/or other measurements for the particular wafer process that is employed. The noise estimator 1210 can be configurable to adjust the noise estimation data 1212 to changing noise conditions. In particular, the noise estimator 1210 can include a look-up table, state machine or other device that stores the noise estimation data 1212 to be used for various conditions indicated by gain signal 352 and/or temperature signal 342. The information will be saved once on the device and regularly accessed to decide on the noise estimation data 1212. Control data 354 that reflects the current operating conditions of the receiver can be used by noise estimation 1210 to select the appropriate noise estimation data 1212 to reflect these operating conditions. In an embodiment, the noise estimator 1210 operates based on control data 354 that indicates temperature and/or gain variations. Whenever the control data 354 indicates that the temperature, gain or a weighted combination thereof, changes by more than a threshold, the noise estimator 1210 can be triggered to update the noise estimation data 1212.

Receiver 1200 further includes a log likelihood module 1202 that responds to subcarrier data to generate likelihood data 1204 for input to the OFDM decoder 314. In an embodiment, the log likelihood module 1202 operates as log-likelihood-ratio (LLR) calculator that receives the subcarrier data 328 and calculates likelihood data 1204 in the form of a probability ratio for each bit, P,

P=Pr(b=1)/Pr(b=0)

This value of P is essentially the likelihood that the transmitted bit was a 0 or 1. Pr(b=1) is the probability that the transmitted bit was a ‘1’; Pr(b=0) is the probability that the transmitted bit was a ‘0’. The channel decoding performed by OFDM decoder 314 uses this probability ratio to decode the bits. For example, a large value of P means there is a high confidence the original transmitted bit was a ‘1’. Close to zero P value means there is a high confidence the original transmitted bit was a ‘0’. A P value of 1 means there is a 50/50 chance the transmitted bit was a 0 or 1 (for example, a well-designed channel decoder discards P values of 1 as they contain no real information).

As shown, the log likelihood module 1202 uses noise estimation data 1212 such as a noise variance or other noise data to be able to make all these calculations and provide P values as described in the above. In particular, the noise estimation data 1212 indicates the 1/f or 1/f² noise shape, band edge noise or other noise estimated or characterized by the noise estimator 1210. Depending on the position of a subcarrier and the noise indicated by the noise profile corresponding to that frequency/subcarrier, the log likelihood module 1202 can use a different noise variance for calculation involving that subcarrier. In this fashion, the subcarriers with higher noise will indirectly have P values that reflect less fidelity/confidence than subcarriers not impacted with such noise.

As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may also be used herein, the terms “processing module”, “module”, “processing circuit”, and/or “processing unit” (e.g., including various modules and/or circuitries such as may be operative, implemented, and/or for encoding, for decoding, for baseband processing, etc.) may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may have an associated memory and/or an integrated memory element, which may be a single memory device, a plurality of memory devices, and/or embedded circuitry of the processing module, module, processing circuit, and/or processing unit. Such a memory device may be a read-only memory (ROM), random access memory (RAM), volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the steps and/or functions illustrated in one or more of the Figures. Such a memory device or memory element can be included in an article of manufacture.

Various embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

A physical embodiment of an apparatus, an article of manufacture, a machine, and/or of a process that includes one or more embodiments may include one or more of the aspects, features, concepts, examples, etc. described with herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

The term “module” is used in the description of the various. A module includes a functional block that is implemented via hardware to perform one or module functions such as the processing of one or more input signals to produce one or more output signals. The hardware that implements the module may itself operate in conjunction software, and/or firmware. As used herein, a module may contain one or more sub-modules that themselves are modules.

While particular combinations of various options, methods, functions and features have been expressly described herein, other combinations of these options, methods, functions and features are likewise possible. The various embodiments are not limited by the particular examples disclosed herein and expressly incorporates these other combinations.

What is claimed is:

1. A receiver for use in a wireless communication device, the receiver comprising:
a radio frequency (RF) front end configurable to receive a received signal that is modulated via orthogonal frequency division multiplexing (OFDM) and configured to generate a downconverted signal, based on the received signal;
an OFDM demodulator, coupled to the RF front end, configurable to generate subcarrier data based on the downconverted signal, wherein the subcarrier data corresponds to a plurality of subcarriers;
a subcarrier weighting module, coupled to the OFDM demodulator, configurable to generate weighted subcarrier data by applying subcarrier weights to the subcarrier data corresponding to selected ones of the plurality of subcarriers; and
an OFDM decoder, coupled to the subcarrier weighting module, configurable to generate decoded OFDM data based on the weighted subcarrier data.

2. The receiver of claim 1 wherein the selected ones of the plurality of subcarriers include at least one low frequency subcarrier and wherein the subcarrier weights compensate for 1/f noise.

3. The receiver of claim 1 wherein the received signal is modulated within an OFDM band, wherein the selected ones of the plurality of subcarriers include at least one subcarrier at an edge of the OFDM band and wherein the subcarrier weights compensate for filter rolloff at the edge of the OFDM band.

4. The receiver of claim 1 wherein the subcarrier weighting module is configurable to adjust the subcarrier weights to changing noise conditions.

5. The receiver of claim 1 wherein the subcarrier weighting module includes:
a weight storage module configurable to store the subcarrier weights corresponding to the selected ones of the plurality of subcarriers; and
a multiplier, coupled to the weight storage module, configurable to multiply the subcarrier weights by the subcarrier data corresponding to the selected ones of the plurality of subcarriers.

6. The receiver of claim 5 wherein the subcarrier weighting module further includes:
a weight estimation module, coupled to the weight storage module, configurable to generate the subcarrier weights based on a noise estimation.

7. The receiver of claim 6 wherein the noise estimation includes an estimation of 1/f noise.

8. The receiver of claim 6 wherein the received signal is modulated within an OFDM band and wherein the noise estimation includes an estimation of noise at the edge of the OFDM band.

9. The receiver of claim 6 wherein the weight estimation module is configurable to detect a quiescent period and to perform the noise estimation during the quiescent period.

10. The receiver of claim 6 wherein the weight estimation module is configurable to adjust the subcarrier weights to changing noise conditions.

11. A method for use in a wireless communication device, the method comprising:
receiving a received signal that is modulated via orthogonal frequency division multiplexing (OFDM);
generating a downconverted signal, based on the received signal;
generating subcarrier data based on an OFDM demodulation of the downconverted signal, wherein the subcarrier data corresponds to a plurality of subcarriers;
generating subcarrier weights corresponding to selected ones of the plurality of subcarriers to reflect noise conditions;
generating weighted subcarrier data by applying the subcarrier weights to the subcarrier data corresponding to the selected ones of the plurality of subcarriers;
generating decoded OFDM data based on the weighted subcarrier data.

12. The method of claim 11 wherein the selected ones of the plurality of subcarriers include at least one low frequency subcarrier and wherein the subcarrier weights compensate for 1/f noise.

13. The method of claim 11 wherein the received signal is modulated within an OFDM band, wherein the selected ones of the plurality of subcarriers include at least one subcarrier at an edge of the OFDM band and wherein the subcarrier weights compensate for filter rolloff at the edge of the OFDM band.

14. The method of claim 11 wherein generating weighted subcarrier data includes:
multiplying the subcarrier weights by the subcarrier data corresponding to the selected ones of the plurality of subcarriers.

15. The method of claim 14 wherein generating the subcarrier weights includes:
generating the subcarrier weights based on a noise estimation.

16. The method of claim 15 wherein the noise estimation includes an estimation of 1/f noise.

17. The method of claim 15 wherein the received signal is modulated within an OFDM band and wherein the noise estimation includes an estimation of noise at the edge of the OFDM band.

18. The method of claim 15 wherein generating the subcarrier weights includes:
detecting a quiescent period; and
generating the noise estimation during the quiescent period.

19. The method of claim 15 wherein generating the subcarrier weights includes:
adjusting the subcarrier weights to changing noise conditions.

20. A receiver for use in a wireless communication device, the receiver comprising:
a radio frequency (RF) front end configurable to receive a received signal that is modulated via orthogonal frequency division multiplexing (OFDM) and configured to generate a downconverted signal, based on the received signal;
an OFDM demodulator, coupled to the RF front end, configurable to generate subcarrier data based on the downconverted signal, wherein the subcarrier data corresponds to a plurality of subcarriers;
a subcarrier weighting module, coupled to the OFDM demodulator, configurable to store subcarrier weights corresponding to selected ones of the plurality of subcarriers and to generate weighted subcarrier data by multiplying the subcarrier weights by the subcarrier data corresponding to selected ones of the plurality of subcarriers; and
an OFDM decoder, coupled to the subcarrier weighting module, configurable to generate decoded OFDM data based on the weighted subcarrier data.
